(19) United States
(12) Patent Application Publication
(10) Pub. No.: US 2009/0172823 A1
(43) Pub. Date: Jul. 2, 2009

(54) MANAGEMENT ENGINE SECURED INPUT

(76) Inventor: Moshe Maor, Santa Clara, CA (US)

Correspondence Address: INTEL CORPORATION;c/o CPA Global, P.O. BOX 52050, MINNEAPOLIS, MN, 55402, US

(21) Appl. No.: 11/967,948

(22) Filed: Dec. 31, 2007

(51) Int. Cl. H04K 1/00

(52) U.S. Cl. 726/29

(57) ABSTRACT

In some embodiments a controller controls an input device, receives input information from the input device, excludes a host processor from controlling the input device, and secures the input information received from the input device so that the input information is not received by the host processor or by any software running on the host processor. Other embodiments are described and claimed.

### RELATED APPLICATIONS

This application is related to the following applications filed on the same date as this application:

“Personal Guard” to Moshe Maor, Attorney Docket Number P25461;

“Personal Vault” to Moshe Maor, Attorney Docket Number P26881;

“Secure Input” to Douglas Gabel and Moshe Maor, Attorney Docket Number P26882;

“Secure Client/Server Transactions” to Moshe Maor, Attorney Docket Number P26890.

### TECHNICAL FIELD

The inventions generally relate to management engine secured input.

### BACKGROUND

Many different types of keyloggers currently exist to allow hackers to hook into different layers in the software stack of a user's computer. The hooking point can be as low (that is, as close to the hardware) as a keyboard base driver or as high (that is, as far from the hardware) as a script that runs inside the scope of an internet browser. In this manner, software based keyloggers and other types of malware may be used by a hacker to hijack sensitive information that a user types into a computer. Therefore, a need has arisen to protect a user's sensitive information from a hacker using keyloggers and other types of malware.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

FIG. 4 illustrates a sequence diagram according to some embodiments of the inventions.

FIG. 5 illustrates a graphic representation according to some embodiments of the inventions.

FIG. 6 illustrates a system according to some embodiments of the inventions.

FIG. 7 illustrates a system according to some embodiments of the inventions.

FIG. 8 illustrates a system according to some embodiments of the inventions.

### DETAILED DESCRIPTION

Some embodiments of the inventions relate to management engine secured input. In some embodiments a controller controls an input device, receives input information from the input device, excludes a host processor from controlling the input device, and secures the input information received from the input device so that the input information is not received by the host processor or by any software running on the host processor.

In some embodiments a method includes controlling an input device, receiving input information from the input device, excluding a host processor from controlling the input device, and securing the input information received from the input device so that the input information is not received by the host processor or by any software running on the host processor.

In some embodiments, a controller operates in three different modes, including a first mode to allow input information from an input device to go directly to software running on a host computer, a second mode to allow input information from the input device to go directly into a secure controller and not to allow the input information from the input device to go to any software running on the host computer, and a third mode to allow input information from the input device to go directly into the secure controller and also to allow the input information from the input device to go to software running on the host computer.

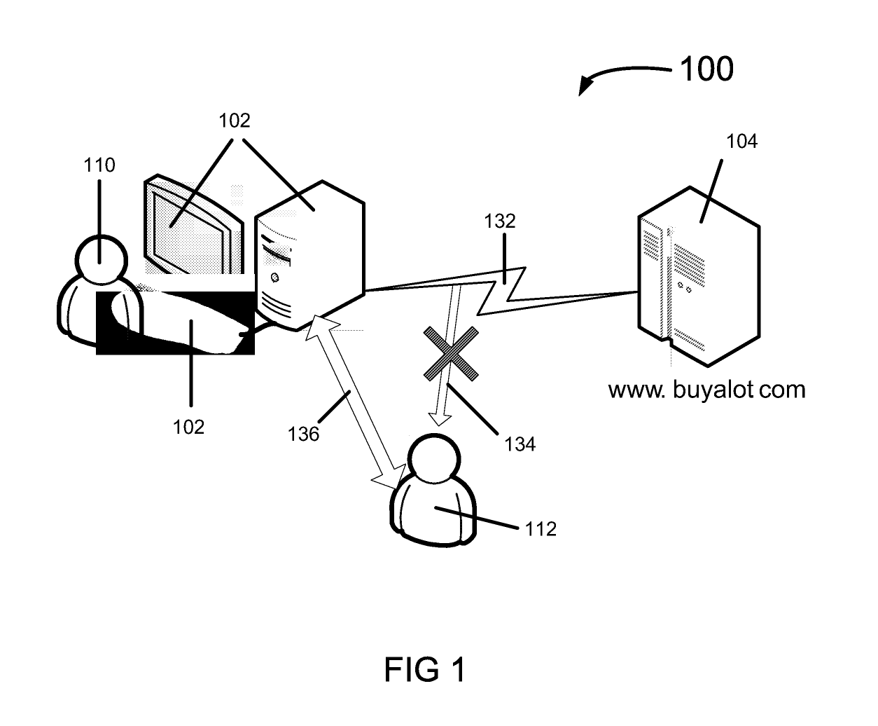

FIG. 1 illustrates a system 100 according to some embodiments. In some embodiments system 100 includes a computer 102 and a remote server 104. FIG. 1 illustrates how an end user 110 (for example, an on-line purchaser of goods and/or services) that is doing some on-line shopping using the computer 102 that is connected to the remote server 104 (for example, via the internet) may be open to attacks from a hacker 112. In the on-line shopping example, a common scenario might include the following numbered steps:

1. The end user 110 is using an internet browser loaded on computer 102 to surf in an e-commerce web site to choose good for purchase (for example, via a remote server 104 of a “www.buyalot.com” web site)
2. The user 110 picks some goods from the “www.buyalot.com” web site and places them into a virtual basket
3. At some point when the user 110 has finished choosing goods for purchase, the user hits a checkout button
4. The e-commerce server 104 opens a form in a window for the user 110 and asks for the user to enter payment information in the form
5. The user 110 types sensitive data into fields of the form such as, for example, a credit card number, phone number, full name, address, etc.
6. The e-commerce server 104 sends back a receipt to the user

During the most sensitive portions of the exemplary scenario discussed above (for example, during steps 4 and 5), the communication between the internet browser of the user 110 and the server 104 of the remote site is typically run on top of a secured connection 132 such as a secure socket layer (SSL) and/or a transfer layer security (TLS), for example. This precludes any adversary such as hacker 112 on the internet that wishes to capture the sensitive data entered by the user from obtaining that data without first breaking cryptographic algorithms used by the secured connected (that is, SSL and/or TLS cryptographic algorithms). This is not typically a problem due to a very high computation complexity that would be required by the hacker 112. Arrow 134 illustrates an attempt by hacker 112 to obtain information via this method. An “X” is included over arrow 134 to illustrate the extreme difficulties in attempting this type of theft attempt.

The typical user 110 is normally aware of the fact that some protection is necessary in order to avoid theft of personal information entered in such a scenario. For example, most users know to look for a special icon normally displayed on a control line of the internet browser that indicates that the current session is being executed over a secured connection. However, a sophisticated hacker 112 may attempt to steal the sensitive information using a completely different approach that is not protected by using a secured connection 132 such as SSL or TLS. For example, in some embodiments, hacker 112 may use a keylogger or other malware to obtain the sensitive information, as illustrated via arrow 136 in FIG. 1. Many different types of keyloggers and/or other malware are currently available, and have the ability to hook into different layers in the software stack running on computer 102, for example. The hooking point for the keyloggers and/or malware can be as low (that is, closer to the hardware) as a keyboard base driver or as high (that is, further from the hardware) as a script that runs inside the scope of the internet browser running on computer 102, for example. Therefore, while it is very important to mitigate network theft attacks on the sensitive data, it is not enough to entirely mitigate theft attacks of sensitive data (resulting, for example, in identity theft).

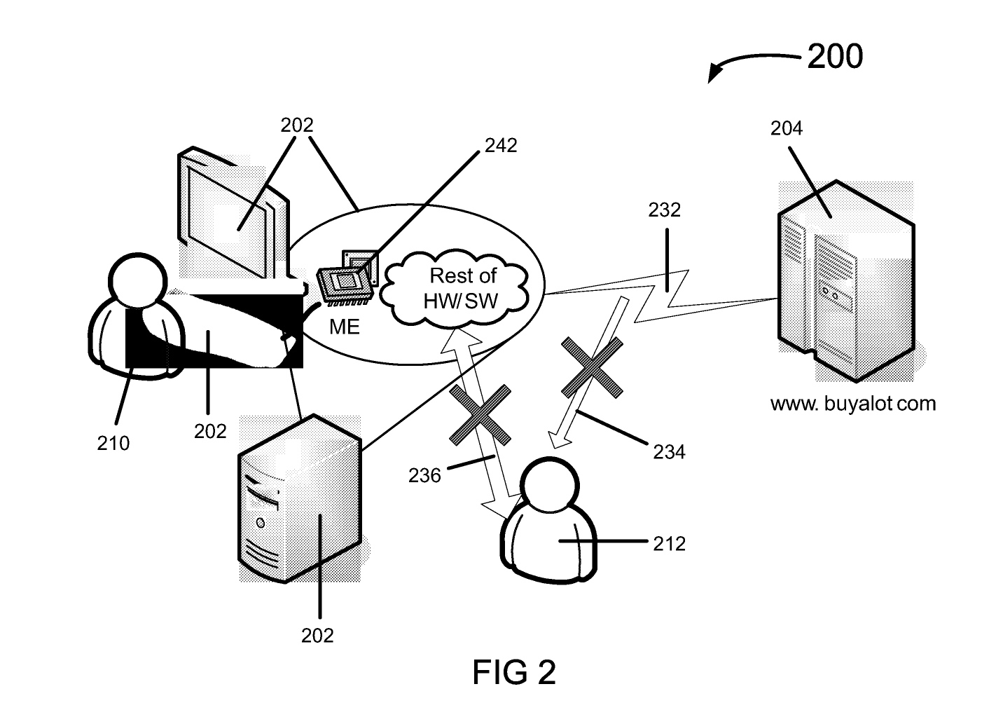

FIG. 2 illustrates a system 200 according to some embodiments. In some embodiments system 200 includes a computer 202 and a remote server 204. FIG. 2 illustrates how an end user 210 (for example, an on-line purchaser of goods and/or services) that is doing some on-line shopping using the computer 202 that is connected to the remote server 204 (for example, via the internet) may guard from attacks from a hacker 212. Similar to the arrangement described in reference to FIG. 1, the communication between the internet browser of the user's computer 202 and the server 204 of the remote site is typically run on top of a secured connection 232 such as a secure socket layer (SSL) and/or a transfer layer security (TLS), for example. This precludes any adversary such as hacker 212 on the internet that wishes to capture the sensitive data entered by the user from obtaining that data without first breaking cryptographic algorithms used by the secured connected (that is, SSL and/or TLS cryptographic algorithms).

Computer 202 includes a management engine (and/or manageability engine and/or ME). In some embodiments, ME 242 is a micro-controller and/or an embedded controller. In some embodiments, ME 242 is included in a chipset of computer 202. In some embodiments, ME 242 is included in a Memory Controller Hub (MCH) of computer 202. In some embodiments, ME 242 is included in a Graphics and Memory Controller Hub of computer 202.

In some embodiments, ME 242 may be implemented using an embedded controller that is a silicon-resident management mechanism for remote discovery, healing, and protection of computer systems. In some embodiments, this controller is used to provide the basis for software solutions to address key manageability issues, improving the efficiency of remote management and asset inventory functionality in third-party management software, safeguarding functionality of critical agents from operating system (OS) failure, power loss, and intentional or inadvertent client removal, for example. In some embodiments, infrastructure supports the creation of setup and configuration interfaces for management applications, as well as network, security, and storage administration. The platform provides encryption support by means of Transport Layer Security (TLS), as well as robust authentication support.

In some embodiments the ME is hardware architecture resident in firmware. A micro-controller within a chipset graphics and memory controller hubs houses Management Engine (ME) firmware, which implements various services on behalf of management applications. Locally, the ME can monitor activity such as the heartbeat of a local management agent and automatically take remediation action. Remotely, the external systems can communicate with the ME hardware to perform diagnosis and recovery actions such as installing, loading or restarting agents, diagnostic programs, drivers, and even operating systems.

Personal guard technology included in system 200 can be used to completely mitigate any attempted attacks from keyloggers and other types of malware. In some embodiments, management engine (and/or manageability engine and/or ME) 242 included within computer 202 takes control over the keyboard of the computer 202 and sets up a trusted path between the user 210 and the ME 242 via any input devices of computer 202 such as the keyboard. Additionally, the ME 242 sets up a secured path (although not a direct connection) between the ME 242 and the remote server 204.

When funneling the sensitive data via the ME 242, the ME 242 actually encrypts the sensitive data that the user 210 types, for example, before the software running on computer 202 obtains the data (for example, sensitive data such as credit card numbers, phone numbers, full name, addresses, etc.) In this manner, when the software that runs on the host processor, for example, of computer 202 is handling the data it is already encrypted and is therefore not usable for keyloggers in an attempt to steal the data via arrow 236 by the hacker 212. Therefore, no matter what type of keylooger is able to infiltrate computer 202 and is currently running on the host processor of computer 202 as part of the software stack, the sensitive data of the user 210 is kept secret when personal guard operations (for example, via ME 242) are being used while user 210 is typing the data.

FIG. 2 has described using personal guard operations to mitigate hacker attempts such as keyloggers from stealing sensitive data entered by a user. However, it is recognized that a management engine such as ME 242 of FIG. 2 is not necessary for all embodiments, and that other devices may be used to implement the same types of operations as described herein. Additionally, an Intel branded ME and/or Intel AMT is not necessary for all embodiments, and other devices may be used to implement the same types of operations as described herein.

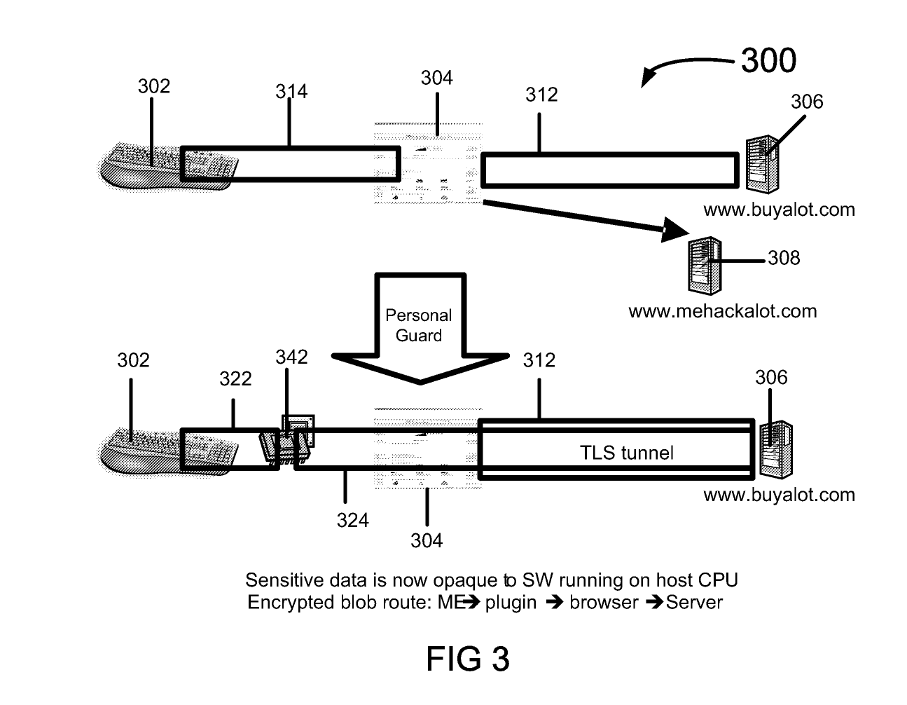

FIG. 3 illustrates a system 300 according to some embodiments. In some embodiments system 300 includes an input device 302 (for example, a keyboard, a mouse, and/or any other type of input device), an Operating System (OS) and/or internet browser 304, a remote server 306, and a hacker (and/or a hacker computer) 308. FIG. 3 illustrates a difference between a system that is guarded by internet based encryption such as SSL or TLS in the top portion of FIG. 3 and a system that is guarded with personal guard technology in a bottom portion of FIG. 3. In the top portion of FIG. 3 a secured connection 312 (for example, using SSL and/or TLS and/or tunneling technology) occurs between the OS/internet browser 304 and the remote server 306, and software based input/output 314 occurs between input device 302 and the OS/internet browser 304. In the scenario illustrated at the top of FIG. 3, the hacker 308 can use malware and/or keyloggers to intercept and make use of sensitive data input by a user. In the bottom of FIG. 3, on the other hand, a secured connection 322 is provided between a portion 342 of a user computer (for example, such as a Management Engine or ME) and the OS/internet browser 304 using personal guard technology according to some embodiments, for example. Additionally, sensitive data is encrypted at 324 between the portion 342 (such as an ME) and the remote server 306 using personal guard technology according to some embodiments, for example. In this manner, software based keyloggers and other types of malware may not be used to hijack sensitive information input by a user at input device 302.

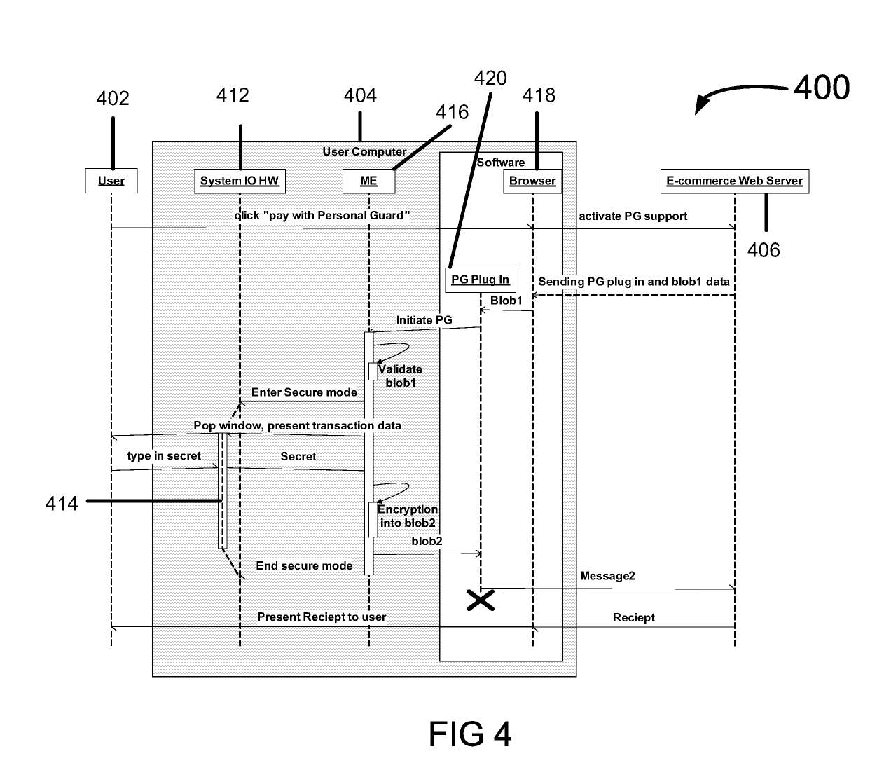

FIG. 4 illustrates a sequence diagram 400 according to some embodiments. Sequence diagram 400 includes a user 402, a computer 404 of the user 402, and a server (for example, an e-commerce web server) 406. Computer 404 includes system input/output hardware (system I/O HW) 412, an input device (for example, a keyboard and/or a mouse) 414, a management engine (and/or manageability engine and/or ME) 416, a browser 418, and a plug in 420. The system I/O HW 412, the input device 414, and the ME 416 are all implemented, for example, in hardware and/or firmware and the browser 418 and the plug in 420 are all implemented, for example, in software. User 402 is a person who is using computer 404 to browse a remote site for which secured input is desired. The user 402 wishes to secure the input using personal guard technology in order to send sensitive information (for example, as part of a transaction) to the remote server 406. System I/O HW 412 is core I/O control implementation within the computer 404 being used by user 402. It is implemented, for example, in the chipset of the computer 404, and includes modules that support secured input and secured output. The input device 414 is an external hardware device through which the user 402 enters sensitive data (for example, by typing in the sensitive data on a keyboard). The ME 416 is also included, for example, in the chipset of the computer 404 of the user 402 and controls the secured I/O flows of the system I/O HW and implements (for example, in firmware) the main personal guard flow. The browser 418 is the software that the user 402 normally executes on the computer 404 to browse web sites on the internet It is noted that personal guard technology according to some embodiments may be used to harden the secured login, for example, of other internet technologies, so a web browser is just an example and is not required in some embodiments. Plug in 420 is a browser plug in used to convey data between the ME 416 (and/or personal guard firmware application) and the remote server 406. The remote server 406 (for example, an e-commerce web server) is a server with which the user 402 is executing some transactions. The server 406 is aware of the personal guard technology being used by the ME 416 and is therefore able to take advantage of secured transactions.

In some embodiments the user 402 clicks a selection such as “pay with Personal Guard” and the browser software 418 then activates Personal Guard support with the server 406. Server 406 then sends a Personal Guard plug in and data (for example, “blob 1”) to the Personal Guard plug in 420 via the browser 418. Plug in 420 then sends an “initiate Personal Guard” signal to the ME 416, which then validates the data (“blob 1”), and causes the user computer 404 to enter a secure mode, causing a pop up window to be displayed to the user 402 in which the user can securely enter sensitive and/or secret data. User 402 enters this data via input device 414 secretly and securely, and the ME 416 encrypts the data (for example, into “blob2”). The encrypted data is then sent via the browser 418 and/or plug in 420 software to the server 406 (for example, as “message2”). The server 406 sends a receipt back to the computer 404, which is presented to the user 402. In this manner any sensitive and/or secret data input by the user 402 to the server 406 via computer 404 is securely transmitted, and software based keyloggers and/or any other types of malware are not able to hijack any of the input data.

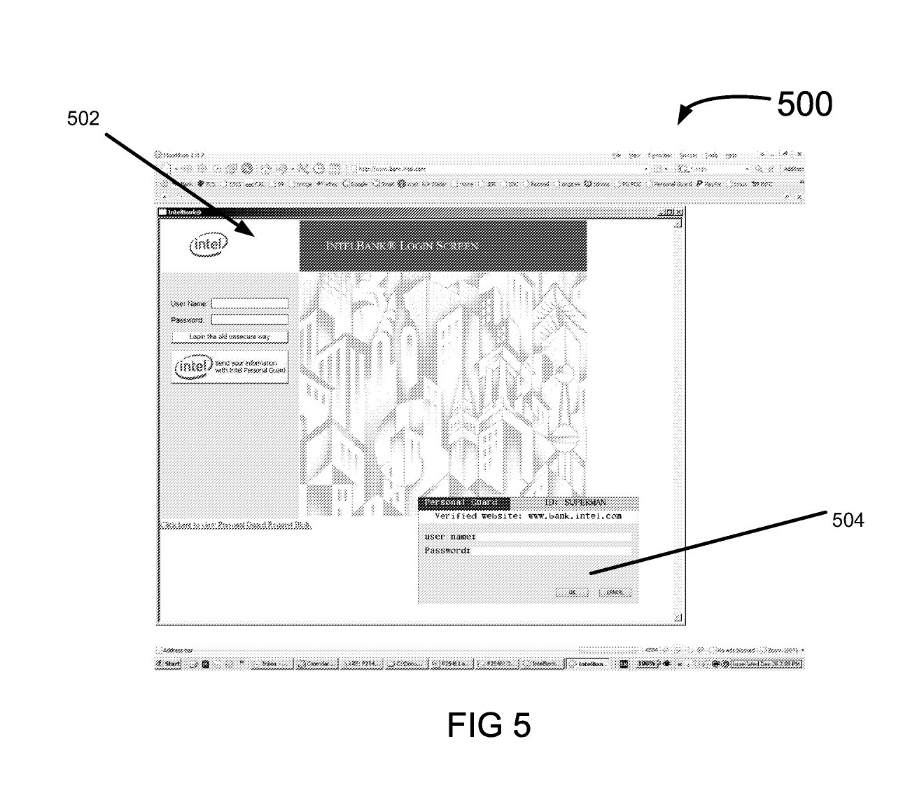

FIG. 5 illustrates a graphic representation 500 according to some embodiments. Graphic representation 500 includes a web site 502 of a vendor (for example, such as a bank or a web site shopping site, etc.) A special Personal Guard login may be used in addition to or instead of the typical web site login. A personal guard window 504 is output on the screen over or beside the web site display, for example, by an ME as secured graphics output through which a user communicates with the ME to convey sensitive information (such as credit card numbers, login credentials, a password to login to a web site, phone number, full name of user, address, social security numbers, etc.)

A personal guard plug-in triggers the ME to show the personal guard window 504. Window 504 cannot be captured by software running on the CPU, for example. When data is encrypted by the ME, it is sent to the server of the web site (for example, a bank web site as shown in FIG. 5). The server of the web site is the only one who can decrypt the data and obtain the ID and/or passcode data, for example. The window 504 includes, for example, a special ID that ensures a user that the ME drew that window (for example, “ID: superman”), an animation (for example, “A” at top left of window 504) that runs when user input goes into the ME, an explicit URL of the remote server to help mitigate address-bar spoofing, which is the number one phishing technique of hackers (for example, in FIG. 5 “www.bank.intel.com”), user credentials such as ID, passcode, etc. stored in secured storage of the ME so that a user does not need to type the data every time (after the initial ME login). The secured input allows the user to enter and manipulate the data, and user data may be clearly shown in window 504 or fully or partially blocked by using, for example, “********”, but in any case whether the data is shown or not shown in window 504 it cannot be read by any software application running on the user's computer or by a hacker trying to use keylogger software and/or other malware.

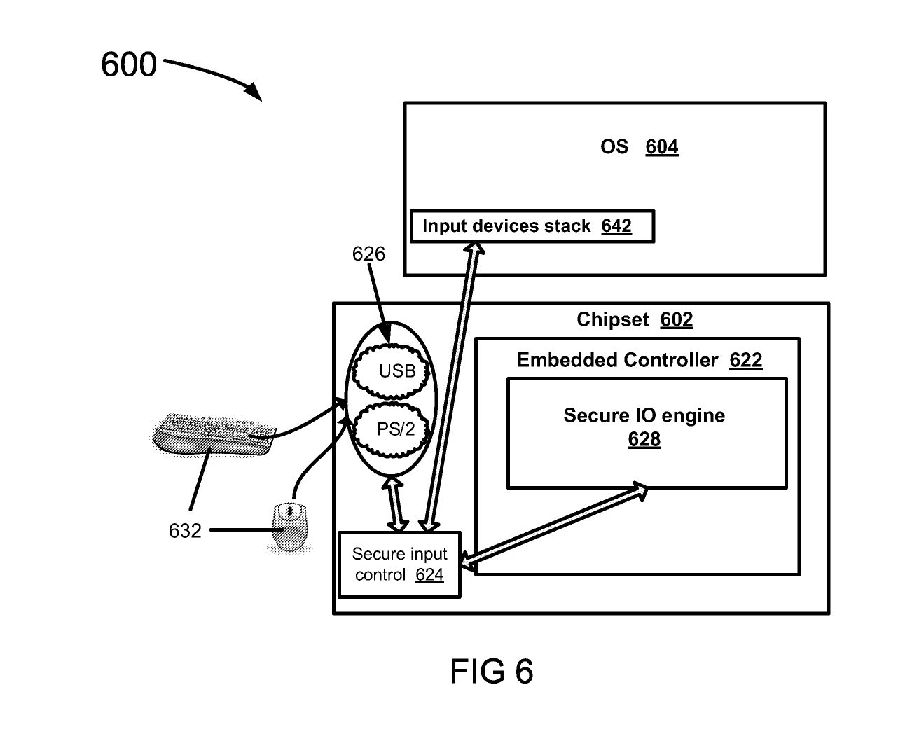

FIG. 6 illustrates a system 600 according to some embodiments. System 600 includes a chipset 602 and an Operating System (OS) 604. Chipset 602 includes an embedded controller 622, secure input control 624, and input device interfaces 626. In some embodiments input device interfaces 626 include a Universal Serial Bus (USB) interface and a PS/2 interface, but may include different types of input device interfaces other than or in addition to USB and PS/2 interfaces (for example, in some embodiments using Bluetooth input devices with a Bluetooth interface). Input device interfaces 626 interface with a variety of external user input devices 632. A keyboard and a mouse are illustrated in FIG. 6 as examples of the types of external input devices 632 that may be included, but other types of external input devices are used in some embodiments. Embedded controller 622 further includes a secure Input/Output (I/O) engine 628 coupled to the secure input control 624. OS 604 includes an input devices software stack 642 that is coupled to the secure input control 624 of the chipset 602.

In some embodiments, by adding a secure input control 624 in the chipset 602, the embedded controller 622 can receive the data from the external input devices 632. It is noted that embedded controller 622 is illustrated in FIG. 6 as being integrated into the chipset 602, but it is noted that in some embodiments embedded controller 622 may be included in a discrete component, embedded into another chip, and/or located on a board of the computer such as the main board or motherboard of the computer. In some embodiments, embedded controller 622 is a Management Engine, a Manageability Engine and/or an ME (all also referred to herein as “ME”). In some embodiments, the ME is embedded in the chipset (for example, embedded in a Memory Controller Hub or MCH of a chipset).

In some embodiments, the embedded controller 622 controls operation such that input data goes directly into the OS 604 and/or software running on the computer. In some embodiments, the embedded controller 622 controls operation such that input data goes directly into the embedded controller 622, and not into the OS 604 and/or software running on the computer (that is, the input is secured and seen only by the embedded controller 622). In some embodiments, the embedded controller 622 controls operation such that input data goes directly into the OS 604 and/or software running on the computer and such that input data goes directly into the embedded controller 622.

In some embodiments, a user can trigger the embedded controller 622 even when the current configuration of the control block 624 is to send the input data directly and only to the OS 604 and/or only to software running on the computer. This allows the end user of the computer to trigger the firmware of the embedded controller 622 during normal system operation in a secured manner that cannot be spoofed by any type of malware running on the host computer. For example, in some embodiments, a user can input a hot-key sequence on a user input device 632 such as a keyboard that triggers the embedded controller 622.

In some embodiments, secure I/O is provided such that a user can directly interact with an embedded controller such as embedded controller 622 and/or an ME. In some embodiments including those illustrated in FIG. 6, a personal guard implementation allows the embedded controller and/or ME to interact with the user and to send his secrets to a remote web server in a secured manner (for example, using encryption). Malware that runs on the host computer, host CPU, and/or OS cannot steal these secrets.

In some embodiments, an embedded controller such as embedded controller 622 has the capability to directly interact with the user and to receive data from the user via an input device in a secured way. In some embodiments “secured input” means that the input data does not pass through the host processor (CPU) and thus is not susceptible to malware that might be running on that CPU that is trying to hijack the data that the user enters.

Other related implementations of secure input from input devices are described in other applications submitted by the inventor of this application and/or by the assignee of this application. For example, in an application entitled “Secure Input” to Douglas Gabel and Moshe Maor, Attorney Docket Number P26882, an implementation relating in some embodiments to USB input devices is disclosed.

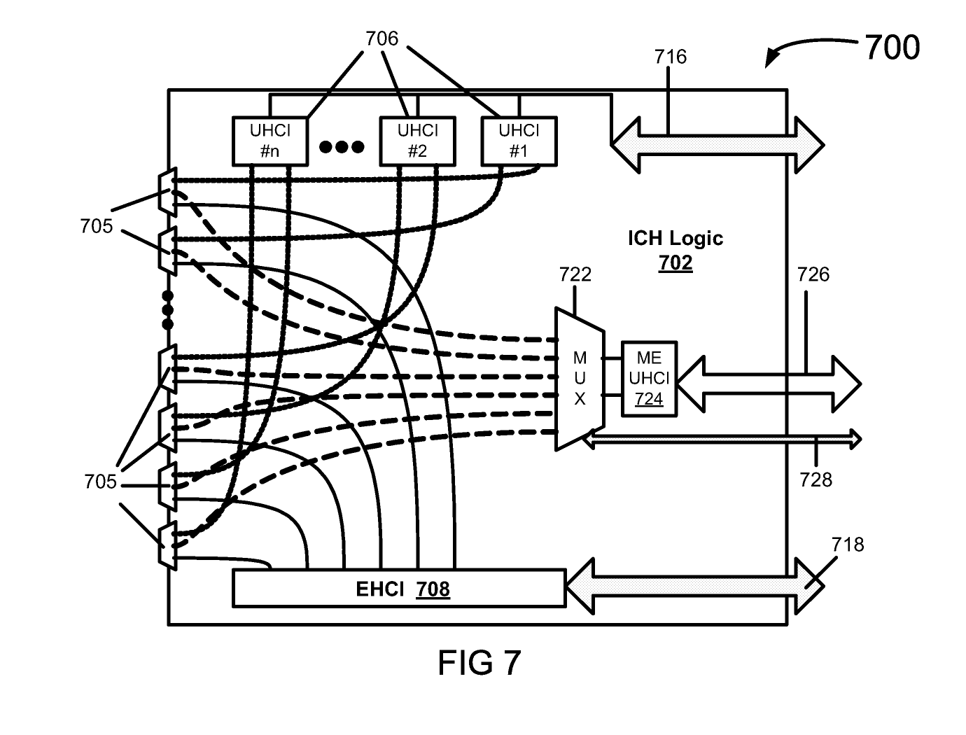

FIG. 7 illustrates a system 700 according to some embodiments. System 700 includes Input/Output Controller Hub (ICH) logic 702 and external input device ports 705. Any number of ports 705 may be included in some embodiments. In some embodiments ports 705 are external USB ports. ICH logic 702 includes Universal Host Controller Interfaces and/or USB Host Controller Interfaces 706 (UHCI) UHCI #1, UHCI #2, . . . UHCI #n, where n is the number of UHCIs and n is any integer number one or greater. In some embodiments such as, for example, in USB embodiments, each of the UHCIs is coupled to two ports 705 and can handle two ports 705. In some embodiments, each of the UHCIs 706 is coupled to the host computer via a host interface 716 to provide host control of the UHCIs 706. ICH logic 702 also includes an Enhanced Host Controller Interface (EHCI) 708 that is coupled to each of the ports 705. In some embodiments, EHCI 708 interfaces with the host computer via a host interface 718 to provide host control of EHCI 708.

In some embodiments, the ICH logic 702 further includes a multiplexer (MUX) 722 and a ME UHCI 724 that is controlled directly by an ME. System 700 also includes an ME:UHCI driver 726 for coupling the ME UHCI 724 to the ME and an ME:routing control interface 728.

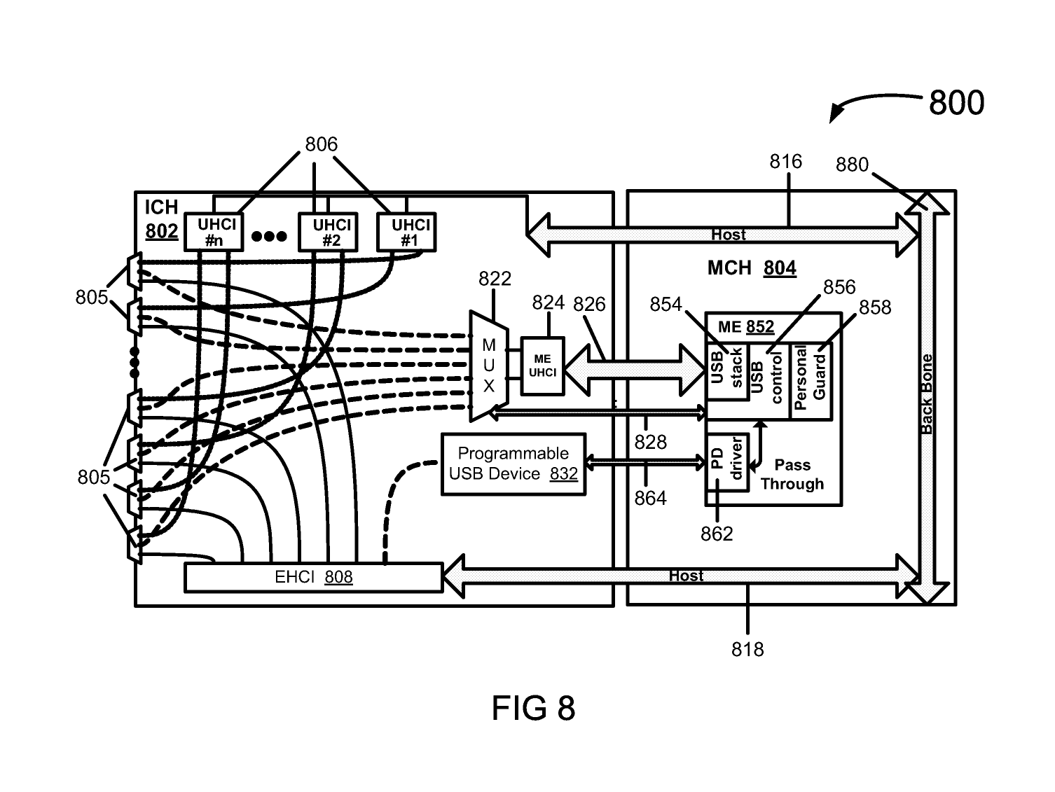

FIG. 8 illustrates a system 800 according to some embodiments. System 800 includes an Input/Output Controller Hub (ICH) 802, a Memory Controller Hub (MCH) 804, and external input device ports 805. Any number of ports 805 may be included in some embodiments. In some embodiments ports 805 are external USB ports. ICH 802 includes Universal Host Controller Interfaces and/or USB Host Controller Interfaces 806 (UHCI) UHCI #1, UHCI #2, UHCI #n, where n is the number of UHCIs and n is any integer number one or greater. In some embodiments such as, for example, in USB embodiments, each of the UHCIs is coupled to two ports 805 and can handle two ports 805. In some embodiments, each of the UHCIs 806 is coupled to the host computer via a host interface 816 and via a backbone 880 to provide host control of the UHCIs 806. ICH 802 also includes an Enhanced Host Controller Interface (EHCI) 808 that is coupled to each of the ports 805. In some embodiments, EHCI 808 interfaces with the host computer via a host interface 818 of the ICH 802 and via the backbone 880 to provide host control of EHCI 808.

In some embodiments, the ICH 802 further includes a multiplexer (MUX) 822 and an ME UHCI 824 that is controlled directly by an ME 852 of the MCH 804. System 800 also includes an ME:UHCI driver 826 to couple the ME UHCI 824 to the ME 852, and an ME:routing control interface 828 to couple the ME 852 to the MUX 822. ME 852 of the MCH 804 includes an interface stack 854 (for example, a USB stack), interface control 856 (for example, USB control) and personal guard technology 858. ME 852 further includes a programmable device driver 862 that is coupled via a pass through an interface 864 to a programmable interface device 832 of the ICH 802 (for example, a programmable USB device).

In some embodiments a trusted path is provided between a secured user and an ME by allowing direct control of an input device such as a keyboard by the ME (for example, in some embodiments, by ME 852). Keystrokes that are typed by a user cannot be seen by any kind of software that runs on the host machine, but are received instead by an ME (for example, ME 852). The approach illustrated and described herein is preferable to an approach where keystrokes are conveyed from a user keyboard via a host computer software component to an ME, since in that approach no protection is provided from malicious software (that is, malware) that may be running on the host CPU to, for example, record the keystrokes.

In some embodiments, in order to enable secure input from an input device such as, for example, a USB keyboard, an ME (for example, ME 852) has full control over the input device instead of the host processor. However, most of the time the system is not running in a mode in which the actual user input (keystrokes) need to be consumed by the ME. Therefore, in some embodiments, the ME consumes the user input and passes it through to the host processor. When a secured input scenario is necessary the ME simply consumes the inputs by itself and will not pass the incoming data to the host software.

In some embodiments, routing logic is included in the chipset to allow the ME to control the input device (for example, a keyboard device). In some embodiments, an ME host controller such as an ME USB host controller is attached to an input device so that the ME can control it (for example, ME UHCI 724 and/or ME UHCI 824). In some embodiments, an input device firmware stack in the ME (for example, USB stack 854 in ME 852 is a USB firmware stack) is used to enumerate all devices (enumerate all USB devices) to identify human input devices (HIDs) that it wants to control, to control that device (for example, to control a keyboard or a mouse), and/or to pass-through for endpoints (USB endpoints) that are not part of the boot keyboard (for example, interfaces that are used to expose new keys such as audio and power control). In some embodiments, a programmable device (for example, USB programmable device 832) is included in the ICH to expose a virtual keyboard through which all non-secured input can be directed. In some embodiments, whenever an input device such as a keyboard provides input that needs to go to the host CPU, the programmable device (for example, USB programmable device 832) emulates the input device (such as a keyboard) that will be controlled by the host CPU. Through that emulated input device, the ME can send on the incoming keystrokes.

In some embodiments, an ME UHCI (for example, ME UHCI 724 and/or ME UHCI 824) is added into the ICH. The ME UHCI is controlled directly by an ME (for example, ME 852). ME-controlled routing logic (for example, ME:UHCI drivers 726 and/or 826 and/or ME:routing control 728 and/or 828) is added that allows the ME to control any connected device (such as a USB device) via the ME UHCI.

Although some embodiments have been described herein as being implemented in a particular manner, according to some embodiments these particular implementations may not be required. For example, although some embodiments have been described as using an ME, other embodiments do not require use of an ME.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a controller to control an input device, to receive input information from the input device, to exclude a host processor from controlling the input device, and to secure the input information received from the input device so that the input information is not received by the host processor or by any software running on the host processor.

2. The apparatus of claim 1, further comprising a host controller interface to interface between the input device and the controller without allowing the host processor to control the input device.

3. The apparatus of claim 1, the controller to allow some input information from the input device to be received by the host processor.

4. The apparatus of claim 1, the controller to allow no input information from the input device to be received by the host processor.

5. The apparatus of claim 1, further comprising a device to emulate the input device to allow the controller to send input information from the input device to the host processor.

6. The apparatus of claim 1, further comprising routing logic to allow the controller to control the input device.

7. The apparatus of claim 1, wherein the input device is a Universal Serial Bus input device.

8. The apparatus of claim 1, wherein the controller includes a firmware stack to enumerate input devices to allow the controller to identify one or more input devices to control, and the firmware stack is to control the identified devices.

9. The apparatus of claim 1, wherein the controller is to identify one or more input devices to control and to control the identified devices.

10. The apparatus of claim 1, wherein the controller is to have full control over the input device.

11. The apparatus of claim 1, wherein the controller is included in a chipset.

12. The apparatus of claim 1, wherein the controller is a discrete controller.

13. The apparatus of claim 1, wherein the controller is embedded in another chip.

14. The apparatus of claim 1, wherein the controller is a management engine.

15. A method comprising:
controlling an input device;
receiving input information from the input device;
excluding a host processor from controlling the input device; and
securing the input information received from the input device so that the input information is not received by the host processor or by any software running on the host processor.

16. The method of claim 15, further comprising allowing some input information from the input device to be received by the host processor.

17. The method of claim 15, further comprising allowing no input information from the input device to be received by the host processor.

18. The method of claim 15, emulating the input device to allow the controller to send input information from the input device to the host processor.

19. The method of claim 15, further comprising identifying one or more input devices to control and controlling the identified devices.

20. An apparatus comprising:
a controller to operate in three different modes, including:
a first mode to allow input information from an input device to go directly to software running on a host computer;
a second mode to allow input information from the input device to go directly into a secure controller and not to allow the input information from the input device to go to any software running on the host computer; and
a third mode to allow input information from the input device to go directly into the secure controller and also to allow the input information from the input device to go to software running on the host computer.

21. The apparatus of claim 20, further comprising routing logic to allow the controller to control the input device.

22. The apparatus of claim 20, wherein the input device is a Universal Serial Bus input device.

23. The apparatus of claim 20, wherein the controller is to identify one or more input devices to control and to control the identified devices.

24. The apparatus of claim 20, wherein the controller is to have full control over the input device.

25. The apparatus of claim 20, wherein the controller is included in a chipset.

26. The apparatus of claim 20, wherein the controller is a discrete controller.

27. The apparatus of claim 20, wherein the controller is embedded in another chip.

28. A method comprising:
in a first mode, allowing input information from an input device to go directly to software running on a host computer;
in a second mode, allowing input information from the input device to go directly into a secure controller and not allowing the input information from the input device to go to any software running on the host computer; and
in a third mode, allowing input information from the input device to go directly into the secure controller and also allowing the input information from the input device to go to software running on the host computer.

29. The method of claim 28, wherein the input device is a Universal Serial Bus input device.

30. The method of claim 28, further comprising:
identifying one or more input devices to control; and
controlling the identified devices.

31. The method of claim 28, further comprising fully controlling the input device.
